(19) United States
(12) Patent Application Publication
(10) Pub. No.: US 2024/0298025 A1
(43) Pub. Date: Sep. 5, 2024

(54) CANDIDATE DERIVATION IN A SEARCH RANGE USING TEMPLATE MATCHING FOR VIDEO CODING

(71) Applicant: QUALCOMM Incorporated, San Diego, CA (US)

(72) Inventors: Zhi Zhang, Munich (DE); Vadim Seregin, San Diego, CA (US); Marta Karczewicz, San Diego, CA (US)

(21) Appl. No.: 18/591,547

(22) Filed: Feb. 29, 2024

Related U.S. Application Data
(60) Provisional application No. 63/487,970, filed on Mar. 2, 2023.

(51) Int. Cl. H04N 19/593; H04N 19/105; H04N 19/172; H04N 19/176

(52) U.S. Cl. CPC H04N 19/593; H04N 19/105; H04N 19/172; H04N 19/176

(57) ABSTRACT

An example device for decoding video data includes a processing system configured to determine an initial block vector predictor (BVP) for a current block of video data; determine a set of valid block vector difference (BVD) values using a template size, the valid BVD values being BVD values that, when added to the BVP, refer to a region of a picture that is entirely within a search area of the picture, the region including a reference block and a template, the template having the template size and being used to perform template matching decoder-side block vector derivation; select one of the valid BVD values as a final BVD; add the final BVD to the BVP to form a block vector (BV); generate a prediction block using the BV; and decode the current block using the prediction block.

This application claims the benefit of U.S. Provisional Application No. 63/487,970, filed Mar. 2, 2023, the entire contents of which are hereby incorporated by reference.

### TECHNICAL FIELD

This disclosure relates to video coding, including video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to intra block copy and inter prediction for video codecs (encoders and decoders). In particular, this disclosure describes techniques related to deriving a base block vector, a base motion vector, and/or a block vector difference candidate list for various coding modes, such as intra block copy (IBC) merge mode with block vector differences (IBC-MBVD), IBC advanced motion vector prediction (IBC AMVP) mode, and derivation of a motion vector difference candidate list for affine merge with motion vector difference (MMVD), GEO MMVD mode, and/or MMVD for regular merge mode.

When coding video data using intra block copy, a video coder may construct a block vector predictor (BVP) list including a set of BVP candidates. The video coder may then select one of the BVP candidates as the base block vector for a current block. Per the techniques of this disclosure, the video coder may then determine a set of block vector difference (BVD) values according to a template size. The BVD values may be determined such that, when applied to the BVP, a search region (also referred to herein as a “search range”) for the resulting block vector refers to a region of a picture that is within a search area of the picture for the current block.

These techniques allow intra block copy techniques to be combined with decoder-side motion vector derivation (DMVD) or decoder-side motion vector refinement (DMVR) techniques using a template. When performing DMVD or DMVR, the video coder may refine a motion vector using differences between a template set of samples neighboring the current block and a corresponding set of samples neighboring potential reference blocks identified by a block vector for the current block. While conventional techniques restrict this block vector from extending beyond the bounds of the current picture, the techniques of this disclosure ensure that a search region for the block vector and the block vector difference as applied to the block vector does not extend beyond the bounds of the current picture. In this manner, DMVD or DMVR can be performed for block vectors used in block vector prediction, thereby improving the prediction block generated using intra-block copy, which may thus reduce the bitrate of the coded bitstream.

In one example, a method of decoding video data includes determining an initial block vector predictor (BVP) for a current block of video data; determining a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; selecting one of the valid BVD values as a final BVD for the current block; adding the final BVD to the BVP for the current block to form a block vector (BV) for the current block; generating a prediction block for the current block using the BV; and decoding the current block using the prediction block.

In another example, a device for decoding video data includes a memory configured to store video data; and a processing system comprising one or more processors implemented in circuitry and configured to: determine an initial block vector predictor (BVP) for a current block of video data; determine a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; select one of the valid BVD values as a final BVD for the current block; add the final BVD to the BVP for the current block to form a block vector (BV) for the current block; generate a prediction block for the current block using the BV; and decode the current block using the prediction block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating an example of padding candidates for replacement of a zero-vector in an intra-block copy (IBC) list.

FIGS. 3A-3D are conceptual diagrams illustrating example IBC reference regions depending on a current block position.

FIG. 4 is a conceptual diagram illustrating an example reference area for IBC when a current CTU (m, n) is coded.

FIG. 5 is a conceptual diagram illustrating examples of templates and reference samples in reference pictures.

FIG. 6 is a conceptual diagram illustrating examples of templates and reference samples of the template for a block with sub-block motion.

FIG. 7 is a conceptual diagram illustrating example directions along various diagonal angles.

FIGS. 8 and 9 are conceptual diagrams illustrating examples of flipping a block of video data.

FIG. 10 is a conceptual diagram illustrating an example advanced motion vector prediction (AMVP) process.

FIG. 11 is a block diagram illustrating an example video encoder that may perform the techniques of this disclosure.

FIG. 12 is a block diagram illustrating an example video decoder that may perform the techniques of this disclosure.

FIG. 13 is a flowchart illustrating an example method for encoding a current block in accordance with the techniques of this disclosure.

FIG. 14 is a flowchart illustrating an example method for decoding a current block in accordance with the techniques of this disclosure.

FIG. 15 is a flowchart illustrating an example method of coding (encoding or decoding) a current block of video data using intra block copy and block vector refinement according to the techniques of this disclosure.

FIG. 16 is a block diagram illustrating an example method of constructing a block vector predictor (BVP) candidate list according to techniques of this disclosure.

### DETAILED DESCRIPTION

In general, this disclosure describes techniques related to intra block copy and inter prediction for video codecs (encoders and decoders). In particular, this disclosure describes techniques related to deriving a base block vector, a base motion vector, and/or a block vector difference candidate list for various coding modes, such as intra block copy (IBC) merge mode with block vector differences (IBC-MBVD), IBC advanced motion vector prediction (IBC AMVP) mode, and derivation of a motion vector difference candidate list for affine merge with motion vector difference (MMVD), GEO MMVD mode, and/or MMVD for regular merge mode.

In general, IBC includes predicting a current block of video data using a block vector that identifies a reference block in a picture including the current block. In some examples, a video coder (encoder or decoder) may refine the block vector using decoder-side block vector refinement techniques, such as template matching. In order to perform template matching, samples of a template neighboring a reference block identified by an initial block vector must be available, e.g., within the picture including the current block.

In some examples, performance of IBC merge mode with block vector differences (IBC-MBVD) mode includes derivation of a BVD candidates list of eight candidates for each block vector predictor (BVP). Template matching may be used to reorder 80 candidates, where the 80 candidates have a distance to the BVP from a distance set of {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and in two horizontal directions (left and right) and two vertical directions (up and down).

Some techniques require three BV validations for each template matching cost calculation process, which include BV for BVP+current BVD, BVP+current BVD+above template shift and BVP+current BVD+left template shift. The first BV validation is to determine whether the current BVD is a valid candidate or not. The other two BV validations are performed to derive the template block vector offset. When the template BV is determined to be not valid, the template offset is set to zero. When the template BV is determined to be valid, the above template shift is set to (0, −templateSize), and the left template shift is set to (−templateSize, 0). Considering the amount number of TM process for each BVP, this three times BV validation is not a good trade off in term of performance and complexity. Therefore, this disclosure describes techniques for validating block vectors using fewer validation operations, which may improve performance of a video coder.

Per the techniques of this disclosure, the video coder may ensure that a region referred to by a BVP to which a BVD has been applied corresponds to a search region (or search range) that is entirely within the boundaries of the current picture, such that intra block copy can be correctly performed. In the case a BVP to which a BVD has been applied corresponds to a search region that is outside of the boundaries of the current picture, the BVD may be considered invalid, such that the video coder need not use that BVD. In this manner, the techniques of this disclosure allow decoder-side block vector refinement to be performed in combination with intra block copy.

In addition, the BVP list construction may have two BVP candidates for which a difference between the two BVPs is small. The similarity of the BVPs reduces the diversity of the BVP candidates and may impact video coder performance. Therefore, this disclosure describes techniques relating to preventing addition of two BVP candidates to a vector candidate list when at least one of differences between horizontal or vertical components of the two BVP candidates are less than a corresponding threshold. In this manner, candidates added to the vector candidate list will have sufficient differences from each other that at least one of the vector candidates in the list will provide a close approximation of an actual block vector for a block of video data. Thus, these techniques may improve performance of a video coder and reduce a bitrate of a bitstream including coded video data.

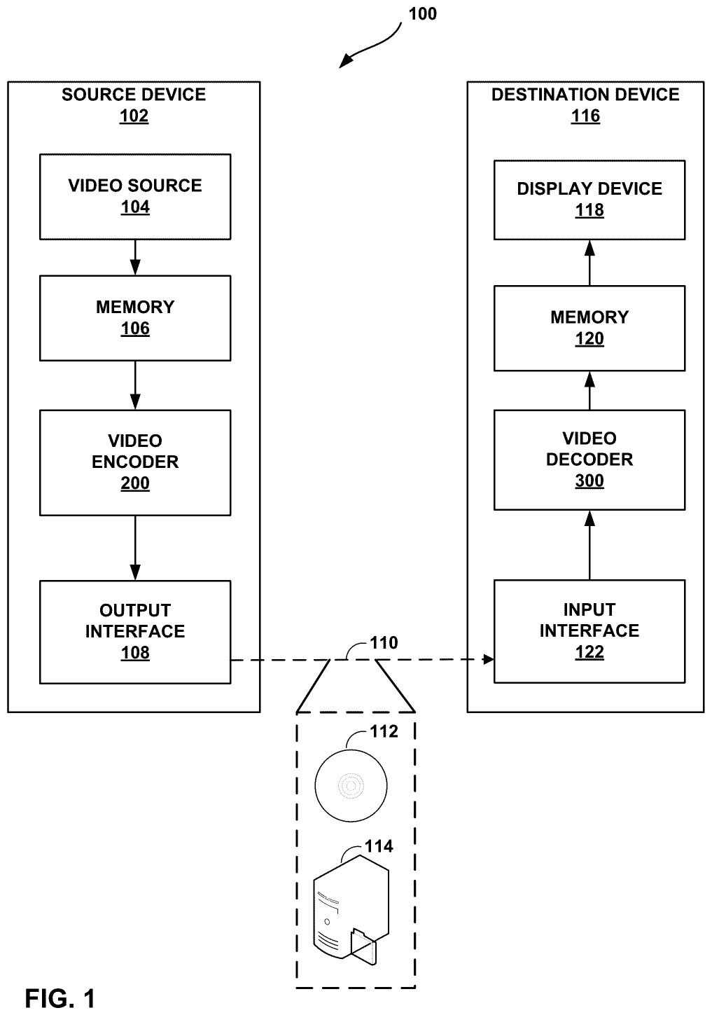

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for deriving candidates in a search range using template matching. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for deriving candidates in a search range using template matching. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that derive candidates in a search range using template matching.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre-and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component may be an array or single sample from one of the three arrays (luma and two chroma) for a picture in 4:2:0, 4:2:2, or 4:4:4 color format, or an array or a single sample of the array for a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra-or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

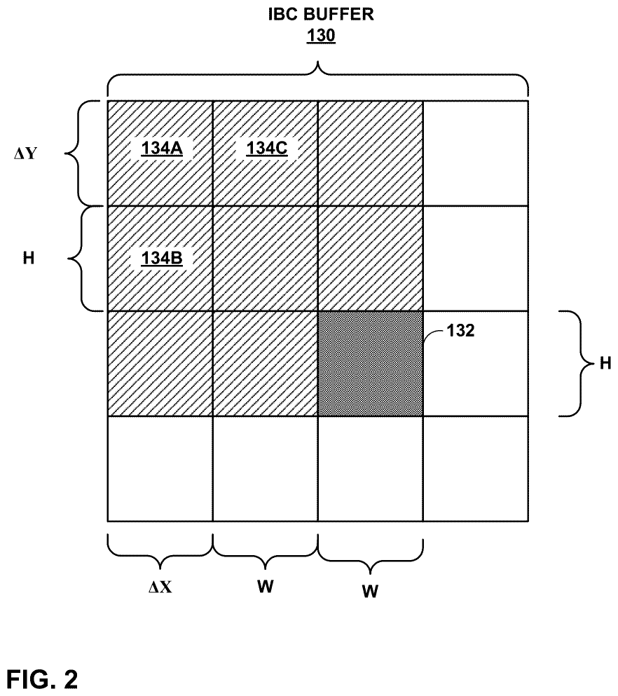

FIG. 2 is a conceptual diagram illustrating an example of padding candidates for replacement of a zero-vector in an intra-block copy (IBC) merge list or advanced motion vector prediction (AMVP) candidate list. In this example, IBC buffer 130 includes a reconstructed region (diagonally shaded blocks) and current block 132. Current block 132, in this example, has a height of H and a width of W. The IBC merge/advanced motion vector prediction (AMVP) list construction process may include determining whether an IBC merge/AMVP candidate is valid, and only then adding the IBC merge/AMVP candidate list into the IBC merge/AMVP candidate list. Above-right, bottom-left, and above-left spatial candidates and a pairwise average candidate may be added into the IBC merge/AMVP candidate list. Template based adaptive reordering (ARMC-TM) may be applied to reorder the IBC merge list.

A history motion vector prediction (HMVP) table size for IBC may include 25 entries. After up to 20 IBC merge candidates are derived with full pruning, video encoder 200 or video decoder 300 may reorder the 20 IBC merge candidates. After reordering, video encoder 200 and video decoder 300 may select the first 6 candidates with the lowest template matching costs as the final candidates in the IBC merge list.

A set of block vector predictor (BVP) candidates located in the IBC reference region may be used to pad the IBC merge/AMVP candidate list. A zero vector may be invalid as a block vector in IBC merge mode, and consequently, not included as a BVP in the IBC candidate list.

Three candidates located on the nearest corners of the reference region, and three additional candidates are determined in the middle of the three sub-regions (134A, 134B, and 134C), whose coordinates may be determined by the width and height of current block 132 and the ΔX and ΔY parameters, as is depicted in FIG. 2.

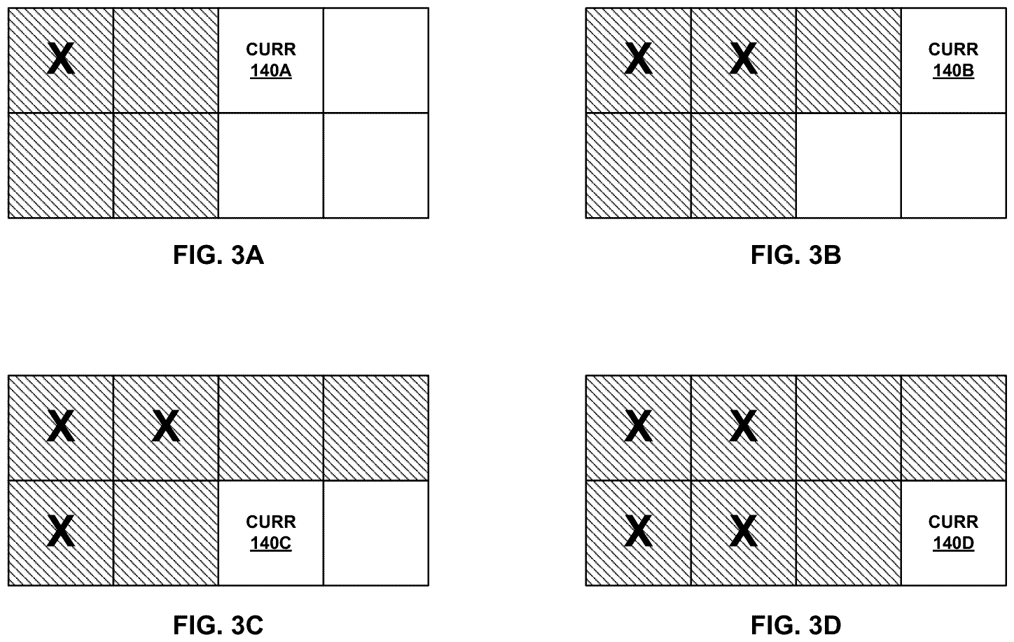

FIGS. 3A-3D are conceptual diagrams illustrating example IBC reference regions depending on a current block position. FIG. 3A depicts current block 140A, FIG. 3B depicts current block 140B, FIG. 3C depicts current block 140C, and FIG. 3D depicts current block 140D. Template Matching is used in IBC for both IBC merge mode and IBC AMVP mode, called respectively as IBC-TM-AMVP and IBC-TM-MRG.

In IBC-TM merge mode, the merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU. In addition, the selected candidates are refined with the Template Matching method prior to the RDO or decoding process. The IBC-TM-MRG mode has been put in competition with the regular IBC merge mode and a TM-merge flag is signaled.

In the IBC-TM-AMVP mode, up to 3 candidates are selected from the IBC-TM-MRG merge list. Each of those 3 selected candidates are refined using the Template Matching method and sorted according to their resulting Template Matching cost. Only the 2 first ones are then considered in the motion estimation process.

The Template Matching refinement for both IBC-TM merge and AMVP modes is quite simple since IBC motion vectors are constrained (i) to be integer and (ii) within a reference region as shown in FIGS. 3A-3D. So, in IBC-TM-MRG mode, all refinements are performed at integer precision, and in IBC-TM-AMVP mode, they are performed either at integer or 4-pel precision depending on the AMVR value. Such a refinement accesses only to samples without interpolation. In both cases, the refined motion vectors and the used template in each refinement step must respect the constraint of the reference region.

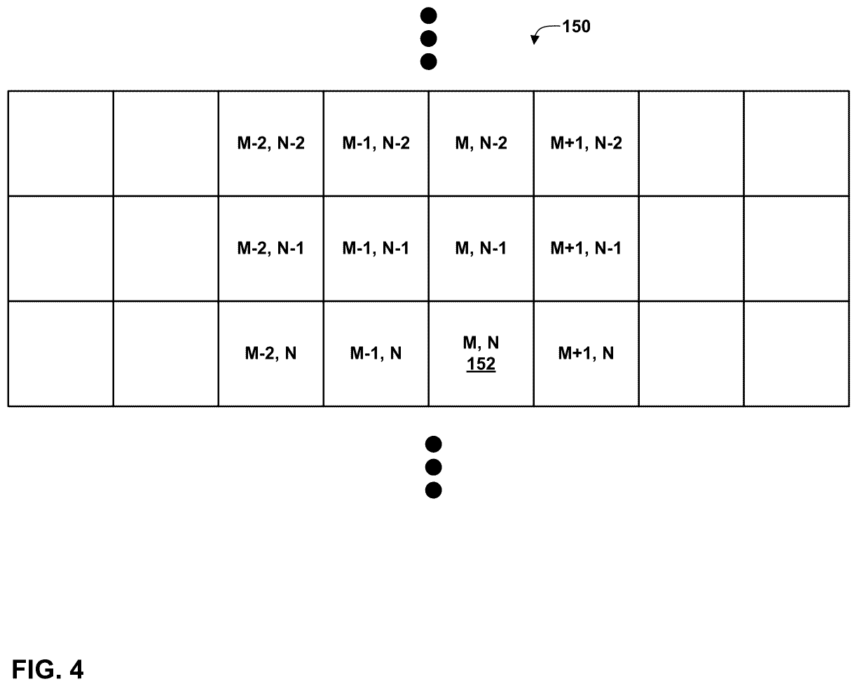

FIG. 4 is a conceptual diagram illustrating an example reference area 150 for IBC when a current CTU (m, n) 152 is coded. Reference area 150 for IBC may include two CTU rows above the CTU row including current CTU 152, as shown in FIG. 4. FIG. 4 illustrates reference area 150 for coding CTU (m, n) 152. Specifically, for CTU (m,n) 152 to be coded, reference area 150 includes CTUs with indexes (m−2,n−2) . . . (W,n−2),(0,n−1) . . . (W,n−1),(0,n) . . . (m,n), where W denotes the maximum horizontal index within the current tile, slice or picture. When CTU size is 256, reference area 150 is limited to one CTU row above. This setting ensures that for CTU sizes of 128 or 256, IBC does not require extra memory. The per-sample block vector search (or local search) range may be limited to [−(C<<1), C>>2] horizontally and [−C, C>>2] vertically to adapt to the reference area extension, where C denotes the CTU size.

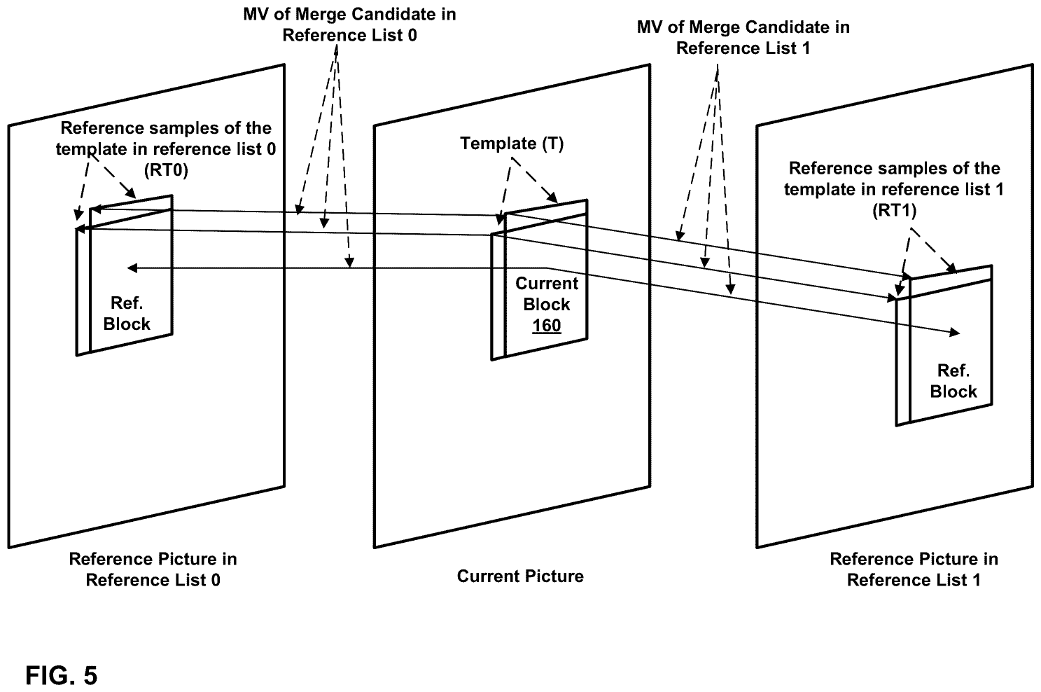

FIG. 5 is a conceptual diagram illustrating examples of templates and reference samples in reference pictures. Video encoder 200 and video decoder 300 may adaptively reorder merge candidates using template matching (TM). The reordering technique may be applied to regular merge mode, TM merge mode, and/or affine merge mode (excluding the SbTMVP candidate). For the TM merge mode, merge candidates may be reordered before the refinement process.

An initial merge candidate list may first be constructed for current block 160 according to a given checking order, such as spatial, TMVPs, non-adjacent, HMVPs, pairwise, or virtual merge candidates. Then the candidates in the initial list may be divided into several subgroups. For template matching (TM) merge adaptive decoder-side motion vector refinement (DMVR) mode, each merge candidate in the initial list may first be refined using TM/multi-pass DMVR. Merge candidates in each subgroup may be reordered to generate a reordered merge candidate list, and the reordering may be performed according to cost values based on template matching. Video encoder 200 may signal an index of a selected merge candidate in the reordered merge candidate list to video decoder 300. For simplification, merge candidates in the last subgroup, but not in the first subgroup, need not be reordered. All zero-candidates from the ARMC reordering process may be excluded during the construction of Merge motion vector candidates list. The subgroup size may be set to 5 for regular merge mode and TM merge mode. The subgroup size may be set to 3 for affine merge mode.

The template matching cost of a merge candidate during the reordering process may be measured by the sum of absolute differences (SAD) between samples of a template of current block 160 and corresponding reference samples. Other difference measures, such as sum of squared difference (SSD), mean absolute difference (MAD), or mean squared difference (MSD), may be used in place of SAD. The template may include a set of reconstructed samples neighboring the current block. Reference samples of the template are indicated by the motion information (e.g., a block vector or motion vector) of the merge candidate. When a merge candidate utilizes bi-directional prediction, the reference samples of the template of the merge candidate are also generated by bi-prediction as shown in FIG. 5.

When multi-pass DMVR is used to derive the refined motion to the initial merge candidate list, only the first pass (i.e., PU level) of multi-pass DMVR is applied in reordering. When template matching is used to derive the refined motion, the template size may be set equal to 1. Only one of the above or left template may be used during the motion refinement of TM when the block is flat with block width greater than 2 times of height or narrow with height greater than 2 times of width. TM may be extended to perform 1/16-pel MVD precision. The first four merge candidates are reordered with the refined motion in TM merge mode.

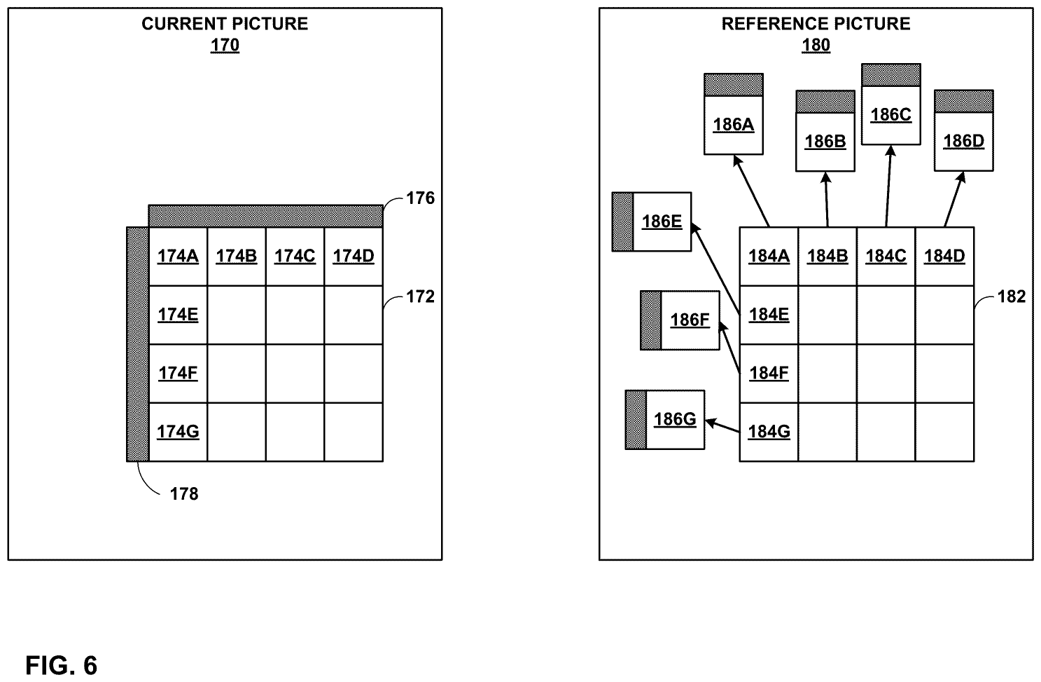

FIG. 6 is a conceptual diagram illustrating examples of templates and reference samples of the template for a block with sub-block motion. In particular, FIG. 6 depicts current picture 170, including current block 172. Current block 172 includes sub-blocks 174A-174G (subblocks 174) neighboring a template, which includes above template 176 and left template 178. For subblock-based merge candidates with subblock size equal to Wsub×Hsub, above template 176 shown in FIG. 5 may include several above sub-templates with sizes of Wsub×1, and left template 178 may include several sub-templates with the size of 1×Hsub. As shown in FIG. 6, the motion information of the subblocks in the first row and the first column of current block may be used to derive the reference samples of each sub-template from reference picture 180.

In particular, in this example, reference picture 180 includes collocated block 182, which is at the same position of reference picture 180 as the position of current block 172 in current picture 170. Thus, collocated block 182 includes collocated sub-blocks 184A-184G. The template information of above template 176 and left template 178 may be used to determine reference sub-blocks 186A-186G using above or left sub-templates neighboring sub-blocks 186A-186G.

In the reordering process, a candidate is considered as redundant if the cost difference between a candidate and its predecessor is inferior to a lambda value, e.g., |D1-D2|<λ, where D1 and D2 are the costs obtained during the first ARMC ordering and λ is the Lagrangian parameter used in the RD criterion of video encoder 200.

Thus, the reordering process may be performed according to the following algorithm:
Determine the minimum cost difference between a candidate and its predecessor among all candidates in the list
   If the minimum cost difference is superior or equal to λ, the list is considered diverse enough and the reordering stops.
   If this minimum cost difference is inferior to λ, the candidate is considered as redundant and it is moved to a position further in the list. This further position is the first position where the candidate is diverse enough compared to its predecessor.
The algorithm stops after a finite number of iterations (if the minimum cost difference is not inferior to λ).

This algorithm may be applied to Regular, TM, BM, and Affine merge modes. A similar algorithm may be applied to the Merge MMVD and sign MVD prediction methods, which also use adaptive reordering of merge candidates (ARMC) for the reordering.

The value of λ may be set equal to the λ of the rate distortion criterion used to select the best merge candidate at the encoder side for low delay configuration and to the value λ corresponding to a another QP for Random Access configuration. A set of λ values corresponding to each signaled QP offset may be signaled in the sequence parameter set (SPS), picture parameter set (PPS), adaptation parameter set (APS), or in the slice header for the QP offsets which are not present in the SPS or other parameter set/syntax structure.

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost greater than a threshold, which is equal to five times of the cost of the first MVP candidate, is skipped. When wrap around motion compensation is enabled, the MV candidate may be clipped with wrap around offset taken into consideration.

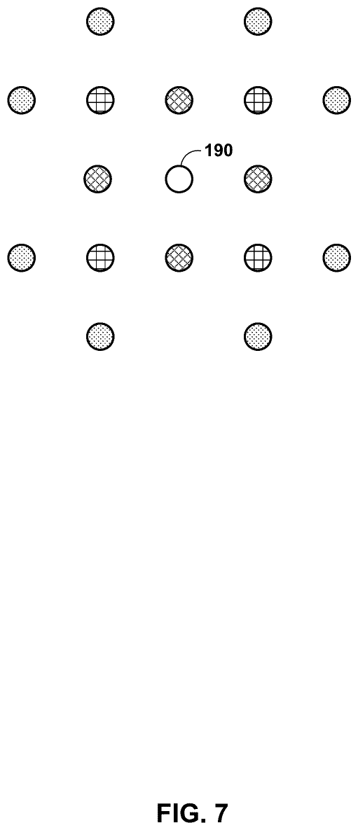

FIG. 7 is a conceptual diagram illustrating example directions along various diagonal angles. MMVD offsets may be extended for MMVD and affine MMVD modes. Additional refinement positions along k×π/8 diagonal angles, as shown in FIG. 7 relative to sample 190, thus increasing the number of directions from 4 to 16. Second, based on the SAD cost between the template (one row above and one column left to the current block) and its reference for each refinement position, all the possible MMVD refinement positions (16×6) for each base candidate may be reordered. Finally, the top ⅛ refinement positions with the smallest template SAD costs may be kept as available positions for MMVD index coding. The MMVD index may be binarized using a rice code with parameter 2. The affine MMVD reordering may be extended, in which additional refinement positions along k×π/4 diagonal angles are added. After reordering the top ½ refinement positions with the smallest template, SAD costs may be stored.

The first N motion candidates in the candidate list before being reordered may be used as the base candidates for MMVD and affine MMVD. N may be equal to 3 for MMVD, and [1, 3] depending on the neighboring block affine flags for affine MMVD. Two ways of adding MMVD offsets may be used, including the ‘two-side’ and ‘one-side’, depending on whether the offset of the other reference picture list is mirrored or directly set to zero. Which way is applied to one block may depend on the TM cost.

Geometric partitioning mode (GPM) may include applying motion vector refinement on top of the existing GPM uni-directional MVs of VVC. A flag may first be signalled for a GPM CU, to specify whether this mode is used. If the mode is used, each geometric partition of a GPM CU may further include a signaled MVD. If MVD is signalled for a geometric partition, after a GPM merge candidate is selected, the motion of the partition is further refined by the signalled MVDs information. All other procedures are kept the same as in GPM of VVC.

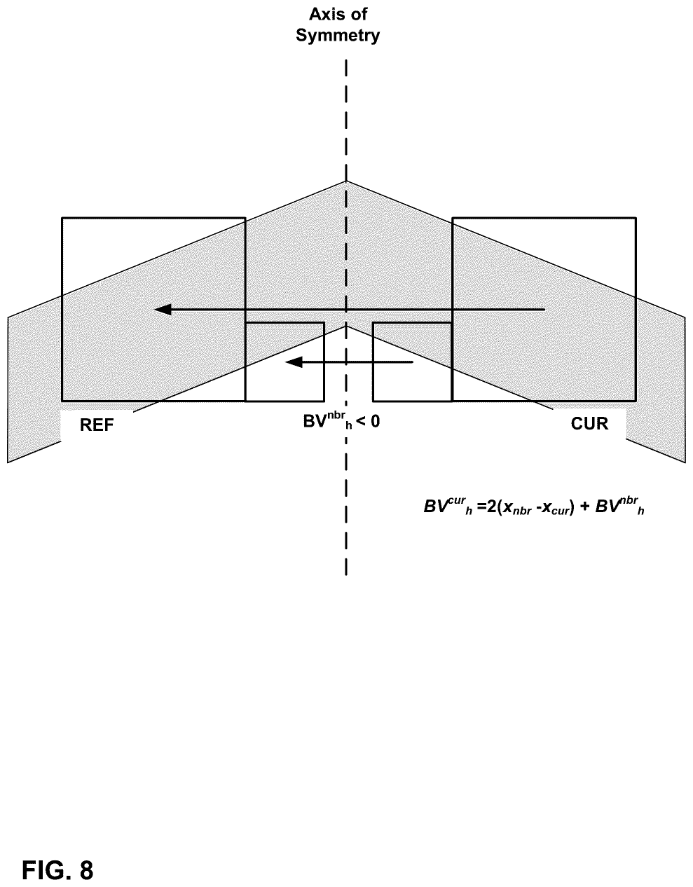

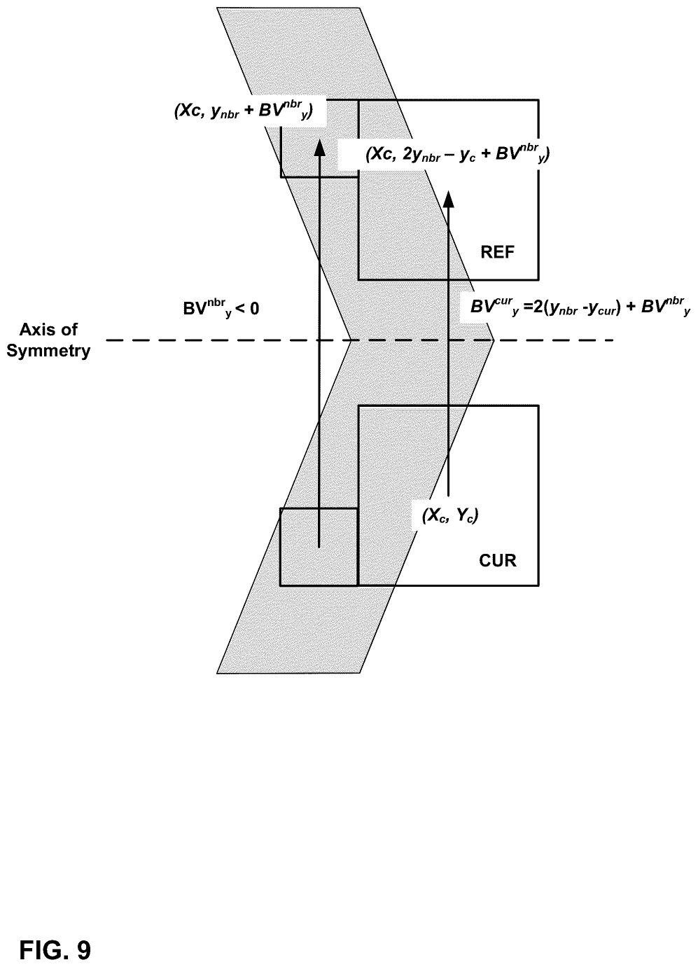

FIGS. 8 and 9 are conceptual diagrams illustrating examples of flipping a block of video data. A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

To better utilize the symmetry property, a flip-aware BV adjustment approach is applied to refine the block vector candidate. For example, as shown in FIGS. 8 and 9, (x_{nbr}, y_{nbr}) and (x_{cur}, y_{cur}) represent the coordinates of the center sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2(x^{nbr}−x^{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2(y_{nbr}−y_{cur})+BV^{nbr}ᵥ.

MMVD mode may be extended to IBC merge mode. In IBC-MBVD, the distance set may be {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions may include the two horizontal directions (left and right) and two vertical directions (up and down).

The base candidates may be selected from the first five candidates in the reordered IBC merge list. Based on the SAD cost (or other cost measure) between the template (one row above and one column left to the current block) and its reference for each refinement position, the possible MBVD refinement positions (20×4) for each base candidate may be reordered. Finally, the top 8 refinement positions with the lowest template SAD costs may be kept as available positions, consequently for MBVD index coding. The MBVD index may be binarized using a rice code with parameter 1. An IBC-MBVD coded block need not inherit flip type from a RR-IBC coded neighbor block.

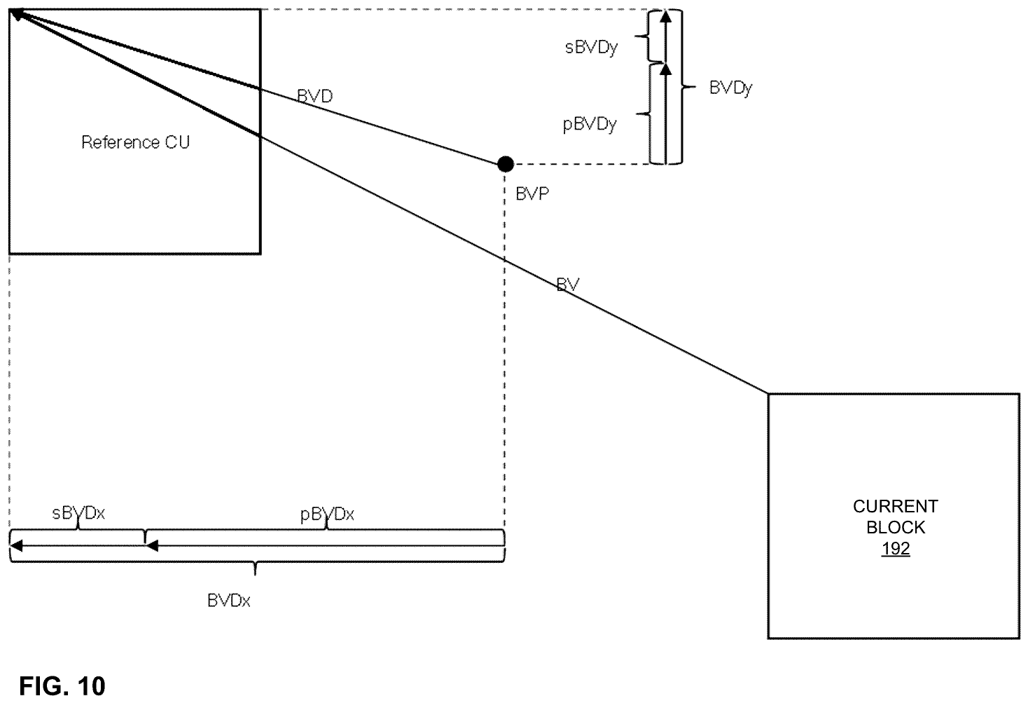

FIG. 10 is a conceptual diagram illustrating an example advanced motion vector prediction (AMVP) process. In an AMVD process, a block vector (BV) may be determined for current block 192 using a full search, a block vector predictor (BPV) may be selected from a BVP candidate list that is sorted as discussed above, and a block vector difference (BVD) may be calculated as BVD=BV−BVP. The BVD may be signaled as split prefixes and suffixes. In particular, a horizontal component of the BVD may be split into a horizontal prefix and a horizontal suffix, while a vertical component of the BVD may be split into a vertical prefix and a vertical suffix. Thus, the BVD may be signaled as BVDx=(pBVDx+sBVDx, BVDy=pBVDy+sBVDy), where “p” indicates prefix, “s” indicates suffix, “x” indicates a horizontal component, and “y” indicates a vertical component. The first five bins of the prefix values may be context coded, and the suffix values may be coded using fixed length codes, where the length may depend on the prefix value. Table 1 below depicts examples of encoded values for various BVD values in this manner:

TABLE 1

| BVD value | 0-1 | 2-5 | 6-13 | 14-29 | 30-61 | 62-125 | 126-253 |
|---|---|---|---|---|---|---|---|
| Prefix | 0 | 2 | 6 | 14 | 30 | 62 | 126 |
| Suffix bins | 1 | 2 | 3 | 4 | 5 | 6 | 7 |
| Suffix values | 0-1 | 0-3 | 0-7 | 0-15 | 0-31 | 0-63 | 0-127 |

Video encoder 200 and video decoder 300 of FIG. 1 may be configured to perform various techniques for deriving a BVP or MVP list and a BVD or MVD candidate list to achieve a good trade-off between coding performance and coding time.

According to a first example technique, when template matching is applied to derive the BV, video encoder 200 or video decoder 300 determines a valid BVD through addition of the BVD and template size to a BVP to derive a BV for a reference block. The reference block size is extended with the template size. In order for the BV to be considered valid, each sample of the extended reference block may be determined to be in the search range of current block 192, e.g., inside a picture boundary and inside a predefined search range of a block vector.

Given a block size W×H and a template size is equal to T, where an above template has a size of W×T and a left template has a size of T×H, the reference block size may be extended as follows:
If both the above template and the left template of current block 192 are available, the reference block size is extended to (W+T)×(H+T)
If only the above template of current block 192 is available, the reference block size is extended to W×(H+T)
If only the left template of current block 192 is available, the reference block size is extended to (W+T)×H

Given a BVP and BVD, video encoder 200 and video decoder 300 may derive a reference block BV. Using the top-left position of current block 192 and the BV, video encoder 200 and video decoder 300 may derive a position (HOR, VER) of the top-left sample position of the reference block. Video encoder 200 and video decoder 300 may determine that the BV is a valid BV when all the samples of the extended reference block are in the search range of current block 192, e.g., from the top-left sample position to the bottom-right sample position of the extended block are all in the search range. Video encoder 200 and video decoder 300 may derive the top-left and bottom-right sample position of a reference block in various ways as discussed in the examples below.

In one example, when both above and left template of current block 192 are available the top-left sample position of the extended reference block is derived as (HOR-T, VER-T), the reference block has a width of W and a height of H, and the bottom-right sample position of the extended reference block is derived as (HOR+W, VER+H).

In one example, when only the above template of current block 192 is available, the top-left sample position of the extended reference block is derived as (HOR, VER-T), the reference block has a width of W and a height of H, and the bottom-right sample position of the extended reference block is derived as (HOR+W, VER+H).

In one example, when only the left template of current block 192 is available, the top-left sample position of the extended reference block is derived as (HOR-T, VER), the reference block has a width of W and a height of H, and the bottom-right sample position of the extended reference block is derived as (HOR+W, VER+H).

When a BVP is derived from a neighbor block, and the neighbor block is coded with vertical flip type, video encoder 200 and video decoder 300 may determine that current block 192 is coded with a vertical flip type. Thus, the top-left and bottom-right sample position of a reference block may be derived as in the examples below.

In one example, when both above and left template of current block 192 are available, the top-left sample position of the extended reference block is derived as (HOR-T, VER), the reference block has a width of W and a height of H, and the bottom-right sample position of the extended reference block is derived as (HOR+W, VER+H+T).

In one example, when only above template of current block 192 is available, the top-left sample position of the extended reference block is derived as (HOR, VER), the reference block has a width of W and a height of H, and the bottom-right sample position of the extended reference block is derived as (VER+W, VER+H+T).

In one example, when only left template of current block 192 is available, the top-left sample position of the extended reference block is derived as (HOR-T, VER), the reference block has a width of W and a height of H, and the bottom-right sample position of the extended reference block is derived as (HOR+W, VER+H).

When a BVP is derived from a neighbor block, and the neighbor block is coded with horizontal flip type, video encoder 200 and video decoder 300 may determine that current block 192 is coded with a horizontal flip type. The top-left and bottom-right sample position of a reference block may be derived as in the examples below.

In one example, when both the above and left templates of current block 192 are available, the top-left sample position of the extended reference block is derived as (HOR, VER-T), the reference block has a width of W and a height of H, and the bottom-right sample position of the extended reference block is derived as (HOR+W+T, VER+H).

In one example, when only above template of current block 192 is available, the top-left sample position of the extended reference block is derived as (HOR, VER-T), the reference block has a width of W and a height of H, and the bottom-right sample position of the extended reference block is derived as (VER+W, VER+H).

In one example, when only left template of current block 192 is available, the top-left sample position of the extended reference block is derived as (HOR, VER), the reference block has a width of W and a height of H, and the bottom-right sample position of the extended reference block is derived as (HOR+W+T, VER+H).

The HOR, VER, W, H, and T values in the examples above may be expressed in pixel precision. When a BV has fractional pixel precision, the HOR and VER values may be derived by rounding the fractional pixel values to integer pixel values.

A second example technique includes deriving a base block vector or a base motion vector list. The first and second techniques may be used alone or in any combination. The base block vector or base motion vector may be used in IBC-MBVD or MMVD. In the following examples, BVP, MBVD, and BV are used to discuss the second example technique; when used for MMVD: MVP, MMVD, or MV are used.

In one example, video encoder 200 or video decoder 300 may determine or be configured with a threshold TH_VER for a vertical block vector difference and a threshold TH_HOR for a horizontal block vector difference. Video encoder 200 or video decoder 300 may derive the block vector difference by subtracting two candidate block vectors in the horizontal direction and in the vertical direction and calculate the absolute values of these differences. When a candidate in the BVP list has both vertical and horizontal vector differences relative to the current candidate that are less than TH_VER and TH_HOR respectively, the current candidate may be skipped and not inserted to the BVP list.

In one example, the candidate pruning may also consider the MBVD direction. A candidate with a distance to the BVP along the MBVD direction can be used as the final candidate for current block 192. For example, the MBVD direction may be set to +Horizental, −Horizental, +Vertical, or −Vertical. When a candidate in the BVP list that is along the MBVD direction, and the distance, which is derived from the block vector difference, is smaller than a threshold, the current candidate is skipped and not inserted to the BVP list. The block vector difference may be derived by subtracting two candidate block vectors in the horizontal direction and the vertical direction and calculating the absolute value of the subtraction, and the distance may be derived by adding the absolute block vector difference in the horizontal direction and the vertical direction.

For example, when the possible MBVD directions are ±Vertical and ±Horizontal, when a candidate in the BVP list has a block vector difference to the current candidate of (diffHor, diffVer) that meets the conditions of (diffHor is equal to 0 and diffVer is smaller than a threshold) or (diffVer is equal to 0 and diffHor is smaller than a threshold), the current candidate is skipped and not inserted to the BVP list.

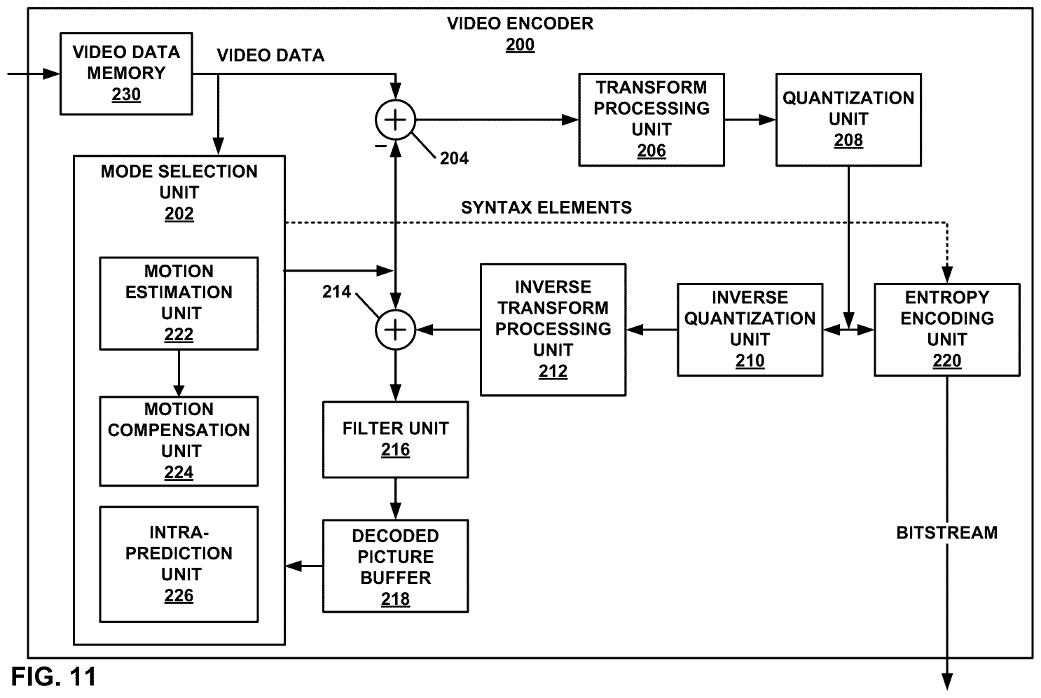

FIG. 11 is a block diagram illustrating an example video encoder 200 that may perform the techniques of this disclosure. FIG. 11 is provided for purposes of explanation and should not be considered limiting of the techniques as broadly exemplified and described in this disclosure. For purposes of explanation, this disclosure describes video encoder 200 according to the techniques of VVC (ITU-T H.266, under development) and HEVC (ITU-T H.265). However, the techniques of this disclosure may be performed by video encoding devices that are configured to other video coding standards and video coding formats, such as AV1 and successors to the AV1 video coding format.

In the example of FIG. 11, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 11 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes. An IBC unit of mode selection unit 202 may be configured to perform any of the various techniques of this disclosure related to coding a block vector for an IBC-predicted block of video data. Mode selection unit 202 may also be configured to perform any of the various techniques of this disclosure related to generating a vector candidate list for, e.g., a block vector or a motion vector.

Per the techniques of this disclosure, intra prediction unit 226 (or a dedicated intra-block copy unit, not shown in the example of FIG. 11) may perform the intra-block copy techniques of this disclosure. For example, intra prediction unit 226 may construct a block vector prediction (BVP) candidate list to be used for intra-block copy (IBC) mode. In some examples, when constructing the BVP candidate list, intra prediction unit 226 may add a new BVP candidate only when the new BVP candidate exceeds at least one of a horizontal threshold or a vertical threshold relative to each existing BVP candidate in the BVP candidate list. Intra prediction unit 226 may therefore ensure that each candidate in the BVP candidate list is sufficiently distinct from each other BVP candidate in the BVP candidate list.

After forming the BVP candidate list, intra prediction unit 226 may select one of the BVP candidates as an initial BVP for a motion vector for a current block. For example, intra prediction unit 226 may select one of the BVP candidates that has a block vector that is most similar to an actual block vector to be used to predict the current block. Intra prediction unit 226 may then provide an index representing the one of the BVP candidates to entropy encoding unit 220 to be encoded as part of the bitstream.

Furthermore, intra prediction unit 226 may determine a set of block vector difference (BVD) values using template matching per the techniques of this disclosure. For example, intra prediction unit 226 may determine a set of valid BVD values using a template size for the current block. Intra prediction unit 226 may classify a BVD value as valid when the BVD value, applied to the initial BVP, refers to a region of the picture including the current block that is entirely within a search area of the picture. This region may include a reference block and a template for the reference block, where the template has the template size and is defined according to template matching decoder-side block derivation. Intra prediction unit 226 may then select one of the valid BVD values of the set as a final BVD value, e.g., based on the template matching process. Intra prediction unit 226 may add the final BVD value to the initial BVP block vector to form a block vector for the current block. Intra prediction unit 226 may then form a prediction block for the current block using the block vector.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 22 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

In this manner, video encoder 200 represents an example of a device for coding video data including a memory configured to store video data; and a processing system comprising one or more processors implemented in circuitry and configured to: determine an initial block vector predictor (BVP) for a current block of video data; determine a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; select one of the valid BVD values as a final BVD for the current block; add the final BVD to the BVP for the current block to form a block vector (BV) for the current block; generate a prediction block for the current block using the BV; and decode the current block using the prediction block.

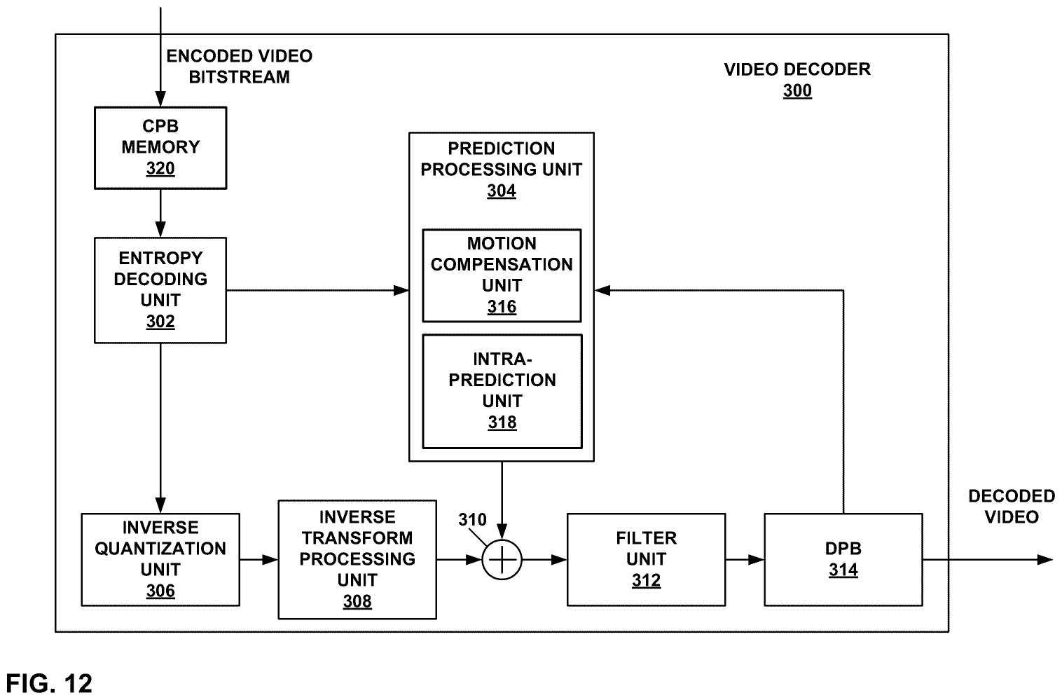

FIG. 12 is a block diagram illustrating an example video decoder 300 that may perform the techniques of this disclosure. FIG. 12 is provided for purposes of explanation and is not limiting on the techniques as broadly exemplified and described in this disclosure. For purposes of explanation, this disclosure describes video decoder 300 according to the techniques of VVC (ITU-T H.266, under development) and HEVC (ITU-T H.265). However, the techniques of this disclosure may be performed by video coding devices that are configured to other video coding standards.

In the example of FIG. 12, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above. An IBC unit of prediction processing unit 304 may be configured to perform any of the various techniques of this disclosure related to coding a block vector for an IBC-predicted block of video data. Prediction processing unit 304 may also be configured to perform any of the various techniques of this disclosure related to generating a vector candidate list for, e.g., a block vector or a motion vector.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 12 are illustrated to assist with understanding the operations performed by video decoder 300. The units may be implemented as fixed-function circuits, programmable circuits, or a combination thereof. Similar to FIG. 11, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 11).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 11). Intra-prediction unit 318 may retrieve data of neighboring samples to the current block from DPB 314.

Per the techniques of this disclosure, intra prediction unit 318 (or a dedicated intra-block copy unit, not shown in the example of FIG. 11) may perform the intra-block copy techniques of this disclosure. For example, intra prediction unit 318 may construct a block vector prediction (BVP) candidate list to be used for intra-block copy (IBC) mode. In some examples, when constructing the BVP candidate list, intra prediction unit 318 may add a new BVP candidate only when the new BVP candidate exceeds at least one of a horizontal threshold or a vertical threshold relative to each existing BVP candidate in the BVP candidate list. Intra prediction unit 318 may therefore ensure that each candidate in the BVP candidate list is sufficiently distinct from each other BVP candidate in the BVP candidate list.

After forming the BVP candidate list, intra prediction unit 318 may select one of the BVP candidates as an initial BVP for a motion vector for a current block. For example, intra prediction unit 318 may receive a decoded index value into the BVP candidate list, where the index value represents the initial BVP.

Furthermore, intra prediction unit 318 may determine a set of block vector difference (BVD) values using template matching per the techniques of this disclosure. For example, intra prediction unit 318 may determine a set of valid BVD values using a template size for the current block. Intra prediction unit 318 may classify a BVD value as valid when the BVD value, applied to the initial BVP, refers to a region of the picture including the current block that is entirely within a search area of the picture. This region may include a reference block and a template for the reference block, where the template has the template size and is defined according to template matching decoder-side block derivation. Intra prediction unit 318 may then select one of the valid BVD values of the set as a final BVD value, e.g., based on the template matching process. Intra prediction unit 318 may add the final BVD value to the initial BVP block vector to form a block vector for the current block. Intra prediction unit 318 may then form a prediction block for the current block using the block vector.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a device for coding video data including a memory configured to store video data; and a processing system comprising one or more processors implemented in circuitry and configured to: determine an initial block vector predictor (BVP) for a current block of video data; determine a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; select one of the valid BVD values as a final BVD for the current block; add the final BVD to the BVP for the current block to form a block vector (BV) for the current block; generate a prediction block for the current block using the BV; and decode the current block using the prediction block.

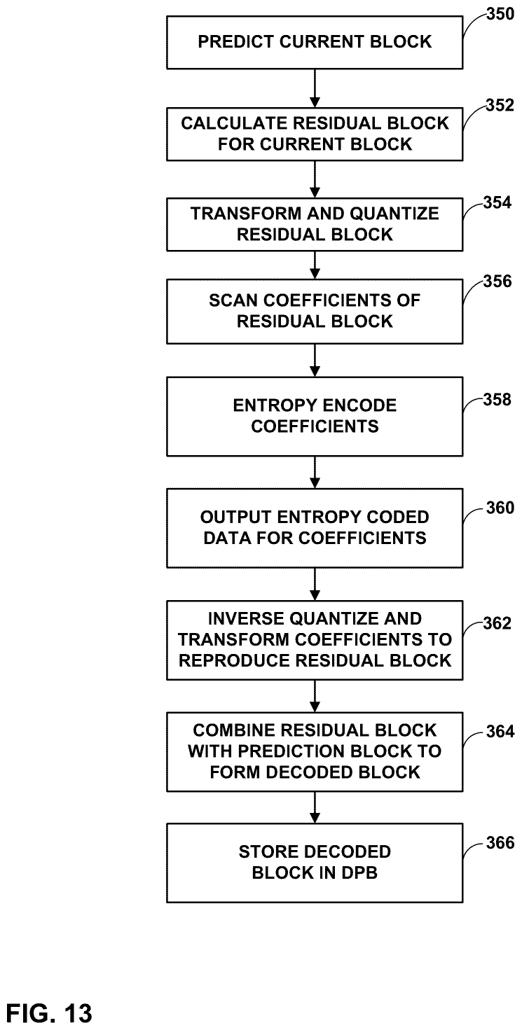

FIG. 13 is a flowchart illustrating an example method for encoding a current block in accordance with the techniques of this disclosure. The current block may comprise a current CU. Although described with respect to video encoder 200 (FIGS. 1 and 11), it should be understood that other devices may be configured to perform a method similar to that of FIG. 13.

In this example, video encoder 200 initially predicts the current block (350). For example, video encoder 200 may form a prediction block for the current block. To form the prediction block, video encoder 200 may form a vector candidate list according to any of the various techniques of this disclosure and select a candidate in the vector candidate list to use as a vector to predict the current block. In addition, or in the alternative, video encoder 200 may validate a block vector using any of the various techniques of this disclosure prior to using the vector as a block vector for IBC mode, e.g., prior to refining the block vector using template matching as discussed above.

Video encoder 200 may then calculate a residual block for the current block (352). To calculate the residual block, video encoder 200 may calculate a difference between the original, uncoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

Video encoder 200 may also decode the current block after encoding the current block, to use the decoded version of the current block as reference data for subsequently coded data (e.g., in inter-or intra-prediction modes). Thus, video encoder 200 may inverse quantize and inverse transform the coefficients to reproduce the residual block (362). Video encoder 200 may combine the residual block with the prediction block to form a decoded block (364). Video encoder 200 may then store the decoded block in DPB 218 (366).

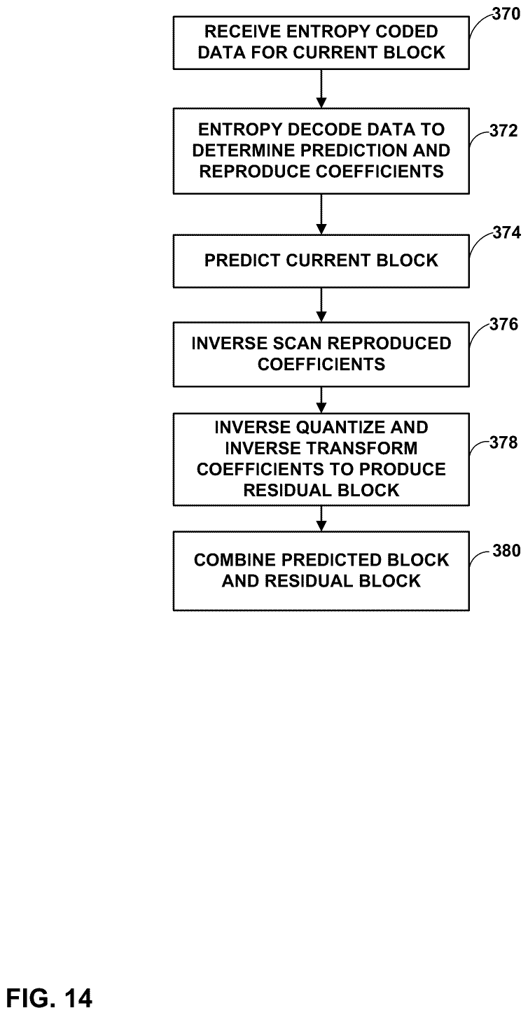

FIG. 14 is a flowchart illustrating an example method for decoding a current block of video data in accordance with the techniques of this disclosure. The current block may comprise a current CU. Although described with respect to video decoder 300 (FIGS. 1 and 12), it should be understood that other devices may be configured to perform a method similar to that of FIG. 14.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra-or inter-prediction mode as indicated by the prediction information for the current block, to calculate a prediction block for the current block. To form the prediction block, video decoder 300 may form a vector candidate list according to any of the various techniques of this disclosure and select a candidate in the vector candidate list to use as a vector to predict the current block. In addition, or in the alternative, video decoder 300 may validate a block vector using any of the various techniques of this disclosure prior to using the vector as a block vector for IBC mode, e.g., prior to refining the block vector using template matching as discussed above.

Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

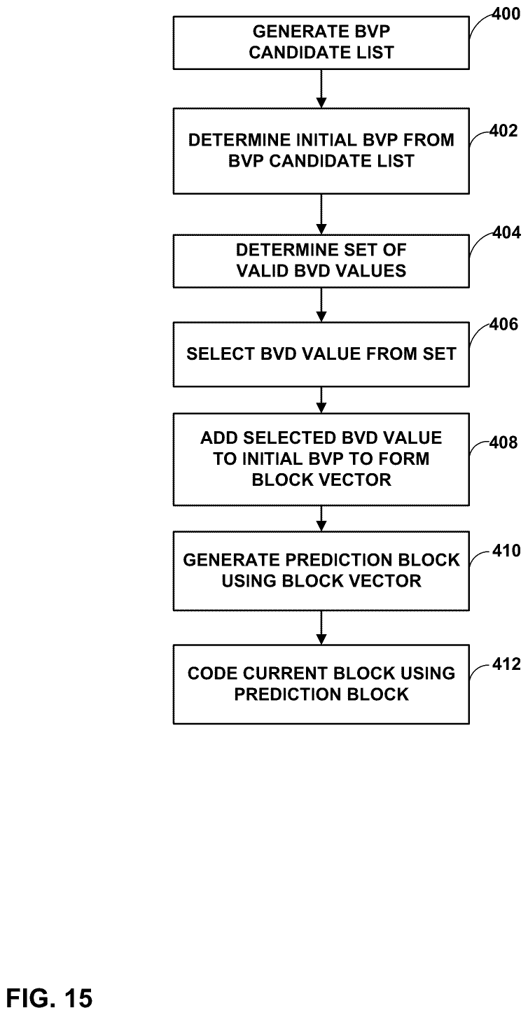

FIG. 15 is a flowchart illustrating an example method of coding (encoding or decoding) a current block of video data using intra block copy and block vector refinement according to the techniques of this disclosure. The method of FIG. 15 may correspond to, for example, step 350 of the method of FIG. 13 or step 374 of the method of FIG. 14. While the method of FIG. 15 may be performed by various devices, such as video encoder 200 or video decoder 300, for purposes of example and explanation, the method of FIG. 15 is explained with respect to video decoder 300.

Initially, video decoder 300 may generate a block vector predictor (BVP) candidate list (400) for a current block of video data. The BVP candidate list may include a set of one or more BVP candidates, representing neighboring (spatial and/or temporal) blocks to the current block that are predicted using intra block copy. Video decoder 300 may then determine an initial BVP from the BVP candidate list (402). For example, video decoder 300 may receive an index corresponding to the initial BVP from the bitstream. When performed during video encoding, video encoder 200 may determine one of the BVP candidates that has motion information that is closest to actual motion information to be used to predict the current block and encode an index into the BVP candidate list corresponding to the determined one of the BVP candidates.

Video decoder 300 may then determine a set of valid block vector difference (BVD) values (404). For example, video decoder 300 may determine a template size for the current block. Video decoder 300 may determine that a BVD value is valid when the BVD value, applied (added) to the initial BVP, refers to a region of a current picture including the current block that is entirely within a search area of the picture for the current block, where the region includes both a reference block referred to by the BVP and a template around the reference block such that the template has the template size. The template may be defined according to template matching decoder-side block vector derivation.

Video decoder 300 may then select one of the BVD values from the set of valid BVD values (406). Video decoder 300 may perform template matching using the BVD values to determine one of the BVD values that, when applied to the BVP, refers to a reference block for which a template neighboring the reference block most closely matches the template neighboring the current block. The closest match may be determined according to a difference metric between samples of the template neighboring the reference block and samples of the template neighboring the current block. For example, the difference metric may be sum of absolute difference (SAD), sum of squared difference (SSD), mean absolute difference (MAD), mean squared difference (MSD), or the like.

Video decoder 300 may then add the selected BVD value to the initial BVP to form a block vector for the current block (408). Video decoder 300 may then generate a prediction block for the current block using the block vector (410). Video decoder 300 may then decode the current block using the prediction block (412). When performed during a video encoding process, after decoding (reconstructing) the current block in this manner, video encoder 200 may store the decoded/reconstructed current block to DPB 218 for use as a reference block during subsequent encoding/decoding operations. Video decoder 300 may store the decoded current block to DPB 314 for reference during subsequent decoding operations, and for output (e.g., to a display).

In this manner, the method of FIG. 15 represents an example of coding (encoding or decoding) video data, including determining an initial block vector predictor (BVP) for a current block of video data; determining a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; selecting one of the valid BVD values as a final BVD for the current block; adding the final BVD to the BVP for the current block to form a block vector (BV) for the current block; generating a prediction block for the current block using the BV; and decoding the current block using the prediction block.

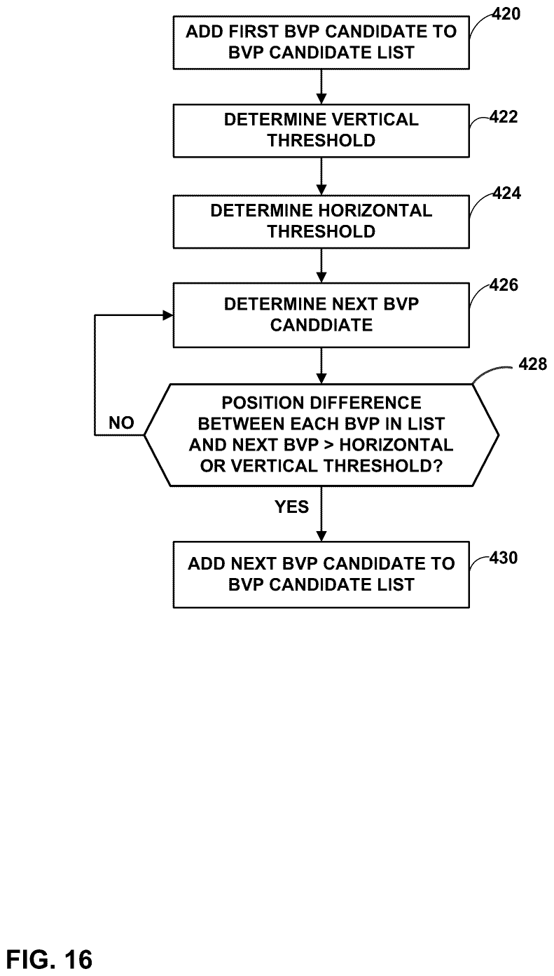

FIG. 16 is a block diagram illustrating an example method of constructing a block vector predictor (BVP) candidate list according to techniques of this disclosure. The method of FIG. 16 may correspond to step 400 of the method of FIG. 15. Thus, the method of FIG. 16 may be performed by video encoder 200, video decoder 300, or other such video coding devices. For purposes of example and explanation, the method of FIG. 16 is explained with respect to video decoder 300.

To generate a BVP candidate list, video decoder 300 may add a number BVP candidates to the BVP candidate list that are sufficiently different from each other. This may ensure that no two BVP candidates are so similar that selecting one or the other results in negligible bitrate differences for the overall bitstream. Accordingly, video decoder 300 may add a first BVP candidate to the BVP candidate list (420). Video decoder 300 may then determine a horizontal threshold (422) and a vertical threshold (424).

Video decoder 300 may then determine a next BVP candidate (426). Video decoder 300 may determine whether a position difference between the next BVP candidate and each BVP candidate currently in the BVP list exceeds at least one of the horizontal threshold or the vertical threshold (428). That is, at least one of a horizontal difference or a vertical difference between the next BVP candidate and each of the existing BVP candidates in the BVP list exceeds the relevant horizontal threshold or vertical threshold. If the next BVP candidate satisfies these criteria (“YES” branch of 428), video decoder 300 may add the next BVP candidate to the BVP candidate list (430). Video decoder 300 may also return to step 426 to determine another next BVP candidate if the BVP candidate list does not yet include a predetermined number of BVP candidates and continue this method until the BVP candidate list includes the predetermined number of BVP candidates. On the other hand, if the next BVP candidate does not satisfy the horizontal and vertical threshold criteria (“NO” branch of 428), video decoder 300 may discard the BVP candidate and select a new next BVP candidate for evaluation per step 426.

In this manner, the method of FIG. 16 represents an example of a method of coding (encoding or decoding) video data including deriving a vector prediction list for a current block of video data, including: determining a vertical threshold for a vertical block vector difference; determining a horizontal threshold for a horizontal block vector difference; adding a first candidate to the vector prediction list; and adding a second candidate to the vector prediction list in response to determining that a vertical difference between the first candidate and the second candidate exceeds the vertical threshold or that a horizontal difference between the first candidate and the second candidate exceeds the horizontal threshold.

The following clauses summarize various examples of the techniques of this disclosure:

Clause 1: A method of decoding video data, the method comprising: determining an initial block vector difference (BVD) for a current block of video data; adding a template size value to the initial BVD to form a final BVD for the current block, the template size value corresponding to a size of a template used to perform template matching decoder-side block vector derivation for the current block; adding the final BVD to a block vector predictor (BVP) for the current block to form a block vector (BV) for the current block; generating a prediction block for the current block using the BV; and decoding the current block using the prediction block.

Clause 2: The method of clause 1, further comprising: determining a location of a reference block using the BVP; determining whether samples within a region defined according to a size of the reference block and the template size value are within a search region; and generating the prediction block for the current block using the BV when the samples within the region are within the search region.

Clause 3: The method of clause 2, wherein the region comprises one of a region above the reference block, a region to the left of the reference block, or both the region above the reference block and the region to the left of the reference block.

Clause 4: The method of clause 2, wherein the region comprises one of a region below the reference block, a region to the right of the reference block, or both the region below the reference block and the region to the right of the reference block.

Clause 5: The method of clause 2, wherein the region comprises one of a region above the reference block, a region to the right of the reference block, or both the region above the reference block and the region to the right of the reference block.

Clause 6: The method of clause 2, wherein the region comprises one of a region below the reference block, a region to the left of the reference block, or both the region below the reference block and the region to the left of the reference block.

Clause 7: A method of decoding video data, the method comprising: deriving a vector prediction list for a current block of video data, including: determining a vertical threshold for a vertical block vector difference; determining a horizontal threshold for a horizontal block vector difference; adding a first candidate to the vector prediction list; and adding a second candidate to the vector prediction list in response to determining that a vertical difference between the first candidate and the second candidate exceeds the vertical threshold or that a horizontal difference between the first candidate and the second candidate exceeds the horizontal threshold; selecting the second candidate as a vector predictor for the current block; generating a prediction block for the current block using the vector predictor; and decoding the current block using the prediction block.

Clause 8: A method comprising a combination of the method of any of clauses 1-6 and the method of clause 7.

Clause 9: The method of any of clauses 7 and 8, wherein first candidate comprises a first block vector predictor and wherein the second candidate comprises a second block vector predictor.

Clause 10: The method of clause 7, wherein first candidate comprises a first motion vector predictor and wherein the second candidate comprises a second motion vector predictor.

Clause 11: The method of any of clauses 7-10, wherein deriving the vector prediction list further comprises skipping addition of a third candidate to the vector prediction list in response to determining that a vertical difference between the third candidate and one of the first candidate or the second candidate is less than the vertical threshold and that a horizontal difference between the third candidate and the one of the first candidate or the second candidate is less than the horizontal threshold.

Clause 12: The method of clause 7, wherein deriving the vector prediction list further comprises skipping addition of a third candidate to the vector prediction list in response to determining that a vertical difference between the third candidate and one of the first candidate or the second candidate is less than the vertical threshold and that a horizontal difference between the third candidate and the one of the first candidate or the second candidate is less than the horizontal threshold.

Clause 13: The method of any of clauses 1-12, further comprising encoding the current block prior to decoding the current block.

Clause 14: A device for decoding video data, the device comprising one or more means for performing the method of any of clauses 1-13.

Clause 15: The device of clause 14, wherein the one or more means comprise one or more processors.

Clause 16: The device of any of clauses 14-15, further comprising a display configured to display the decoded video data.

Clause 17: The device of any of clauses 14-16, wherein the device comprises one or more of a camera, a computer, a mobile device, a broadcast receiver device, or a set-top box.

Clause 18: The device of clause 14-17, further comprising a memory configured to store the video data.

Clause 19: A computer-readable storage medium having stored thereon instructions that, when executed, cause a processor of a device for decoding video data to perform the method of any of clauses 1-13.

Clause 20: A device for decoding video data, the device comprising: means for determining an initial block vector difference (BVD) for a current block of video data; means for adding a template size value to the initial BVD to form a final BVD for the current block, the template size value corresponding to a size of a template used to perform template matching decoder-side block vector derivation for the current block; means for adding the final BVD to a block vector predictor (BVP) for the current block to form a block vector (BV) for the current block; means for generating a prediction block for the current block using the BV; and means for decoding the current block using the prediction block.

Clause 21: A device for decoding video data, the device comprising: means for deriving a vector prediction list for a current block of video data, including: means for determining a vertical threshold for a vertical block vector difference; means for determining a horizontal threshold for a horizontal block vector difference; means for adding a first candidate to the vector prediction list; and means for adding a second candidate to the vector prediction list in response to determining that a vertical difference between the first candidate and the second candidate exceeds the vertical threshold and that a horizontal difference between the first candidate and the second candidate exceeds the horizontal threshold; means for selecting the second candidate as a vector predictor for the current block; means for generating a prediction block for the current block using the vector predictor; and means for decoding the current block using the prediction block.

Clause 22: A method of decoding video data, the method comprising: determining an initial block vector predictor (BVP) for a current block of video data; determining a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; selecting one of the valid BVD values as a final BVD for the current block; adding the final BVD to the BVP for the current block to form a block vector (BV) for the current block; generating a prediction block for the current block using the BV; and decoding the current block using the prediction block.

Clause 23: The method of clause 22, wherein the template comprises a first template and the template size comprises a first template size along a first dimension of the template, and wherein the region of the picture includes the reference block, the first template, and a second template having a second template size along a second dimension of the template, the second dimension being orthogonal to the first dimension.

Clause 24: The method of clause 23, wherein the first template size comprises a height of the template and the second template size comprises a width of the template.

Clause 25: The method of clause 23, wherein the first template is above the reference block and the second template is to the left of the reference block.

Clause 26: The method of clause 23, wherein the first template is below the reference block and the second template is to the right of the reference block.

Clause 27: The method of clause 23, wherein the first template is above the reference block and the second template is to the right of the reference block.

Clause 28: The method of clause 23, wherein the first template is below the reference block and the second template is to the left of the reference block.

Clause 29: The method of clause 22, wherein the template is above the reference block.

Clause 30: The method of clause 22, wherein the template is to the left of the reference block.

Clause 31: The method of clause 22, wherein the template is below the reference block.

Clause 32: The method of clause 22, wherein the template is to the right of the reference block.

Clause 33: The method of clause 22, wherein determining the initial BVP for the current block of video data comprises selecting the initial BVP from a BVP candidate list, the method further comprising: constructing the BVP candidate list, including: determining a vertical threshold for a vertical block vector difference; determining a horizontal threshold for a horizontal block vector difference; adding a first candidate to the BVP candidate list; and adding a second candidate to the BVP candidate list in response to determining that a vertical difference between the first candidate and the second candidate exceeds the vertical threshold or that a horizontal difference between the first candidate and the second candidate exceeds the horizontal threshold; wherein determining the initial BVP for the current block of video data comprises selecting the second candidate as the initial BVP for the current block of video data.

Clause 34: The method of clause 33, wherein constructing the BVP candidate list further comprises skipping addition of a third candidate to the BVP candidate list in response to determining that a vertical difference between the third candidate and one of the first candidate or the second candidate is less than the vertical threshold and that a horizontal difference between the third candidate and the one of the first candidate or the second candidate is less than the horizontal threshold.

Clause 35: The method of clause 22, further comprising encoding the current block prior to decoding the current block.

Clause 36: A device for decoding video data, the device comprising: a memory configured to store video data; and a processing system comprising one or more processors implemented in circuitry and configured to: determine an initial block vector predictor (BVP) for a current block of video data; determine a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; select one of the valid BVD values as a final BVD for the current block; add the final BVD to the BVP for the current block to form a block vector (BV) for the current block; generate a prediction block for the current block using the BV; and decode the current block using the prediction block.

Clause 37: The device of clause 36, wherein the template comprises a first template and the template size comprises a first template size along a first dimension of the template, and wherein the region of the picture includes the reference block, the first template, and a second template having a second template size along a second dimension of the template, the second dimension being orthogonal to the first dimension.

Clause 38: The device of clause 36, wherein to determine the initial BVP for the current block of video data, the processing system is configured to select the initial BVP from a BVP candidate list, and wherein the processing system is further configured to: construct the BVP candidate list, wherein to construct the BVP candidate list, the processing system is configured to: determine a vertical threshold for a vertical block vector difference; determine a horizontal threshold for a horizontal block vector difference; add a first candidate to the BVP candidate list; and add a second candidate to the BVP candidate list in response to a determination that a vertical difference between the first candidate and the second candidate exceeds the vertical threshold or that a horizontal difference between the first candidate and the second candidate exceeds the horizontal threshold; wherein to determine the initial BVP for the current block of video data, the processing system is configured to select the second candidate as the initial BVP for the current block of video data.

Clause 39: The device of clause 38, wherein to construct the BVP candidate list, the processing system is further configured to skip addition of a third candidate to the BVP candidate list in response to a determination that a vertical difference between the third candidate and one of the first candidate or the second candidate is less than the vertical threshold and that a horizontal difference between the third candidate and the one of the first candidate or the second candidate is less than the horizontal threshold.

Clause 40: The device of clause 36, further comprising a display configured to display the decoded video data.

Clause 41: The device of clause 36, wherein the device comprises one or more of a camera, a computer, a mobile device, a broadcast receiver device, or a set-top box.

Clause 42: A device for decoding video data, the device comprising: means for determining an initial block vector predictor (BVP) for a current block of video data; means for determining a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; means for selecting one of the valid BVD values as a final BVD for the current block; means for adding the final BVD to the BVP for the current block to form a block vector (BV) for the current block; means for generating a prediction block for the current block using the BV; and means for decoding the current block using the prediction block.

Clause 43: A computer-readable storage medium having stored thereon instructions that, when executed, cause a processor to: determine an initial block vector predictor (BVP) for a current block of video data; determine a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; select one of the valid BVD values as a final BVD for the current block; add the final BVD to the BVP for the current block to form a block vector (BV) for the current block; generate a prediction block for the current block using the BV; and decode the current block using the prediction block.

Clause 44: A method of decoding video data, the method comprising: determining an initial block vector predictor (BVP) for a current block of video data; determining a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; selecting one of the valid BVD values as a final BVD for the current block; adding the final BVD to the BVP for the current block to form a block vector (BV) for the current block; generating a prediction block for the current block using the BV; and decoding the current block using the prediction block.

Clause 45: The method of clause 44, wherein the template comprises a first template and the template size comprises a first template size along a first dimension of the template, and wherein the region of the picture includes the reference block, the first template, and a second template having a second template size along a second dimension of the template, the second dimension being orthogonal to the first dimension.

Clause 46: The method of clause 45, wherein the first template size comprises a height of the template and the second template size comprises a width of the template.

Clause 47: The method of clause 45, wherein the first template is above the reference block and the second template is to the left of the reference block.

Clause 48: The method of clause 45, wherein the first template is below the reference block and the second template is to the right of the reference block.

Clause 49: The method of clause 45, wherein the first template is above the reference block and the second template is to the right of the reference block.

Clause 50: The method of clause 45, wherein the first template is below the reference block and the second template is to the left of the reference block.

Clause 51: The method of any of clauses 44-50, wherein the template is above the reference block.

Clause 52: The method of any of clauses 44-50, wherein the template is to the left of the reference block.

Clause 53: The method of any of clauses 44-50, wherein the template is below the reference block.

Clause 54: The method of any of clauses 44-50, wherein the template is to the right of the reference block.

Clause 55: The method of any of clauses 44-54, wherein determining the initial BVP for the current block of video data comprises selecting the initial BVP from a BVP candidate list, the method further comprising: constructing the BVP candidate list, including: determining a vertical threshold for a vertical block vector difference; determining a horizontal threshold for a horizontal block vector difference; adding a first candidate to the BVP candidate list; and adding a second candidate to the BVP candidate list in response to determining that a vertical difference between the first candidate and the second candidate exceeds the vertical threshold or that a horizontal difference between the first candidate and the second candidate exceeds the horizontal threshold; wherein determining the initial BVP for the current block of video data comprises selecting the second candidate as the initial BVP for the current block of video data.

Clause 56: The method of clause 55, wherein constructing the BVP candidate list further comprises skipping addition of a third candidate to the BVP candidate list in response to determining that a vertical difference between the third candidate and one of the first candidate or the second candidate is less than the vertical threshold and that a horizontal difference between the third candidate and the one of the first candidate or the second candidate is less than the horizontal threshold.

Clause 57: The method of any of clauses 44-56, further comprising encoding the current block prior to decoding the current block.

Clause 58: A device for decoding video data, the device comprising: a memory configured to store video data; and a processing system comprising one or more processors implemented in circuitry and configured to: determine an initial block vector predictor (BVP) for a current block of video data; determine a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block; select one of the valid BVD values as a final BVD for the current block; add the final BVD to the BVP for the current block to form a block vector (BV) for the current block; generate a prediction block for the current block using the BV; and decode the current block using the prediction block.

Clause 59: The device of clause 58, wherein the template comprises a first template and the template size comprises a first template size along a first dimension of the template, and wherein the region of the picture includes the reference block, the first template, and a second template having a second template size along a second dimension of the template, the second dimension being orthogonal to the first dimension.

Clause 60: The device of any of clauses 58 and 59, wherein to determine the initial BVP for the current block of video data, the processing system is configured to select the initial BVP from a BVP candidate list, and wherein the processing system is further configured to: construct the BVP candidate list, wherein to construct the BVP candidate list, the processing system is configured to: determine a vertical threshold for a vertical block vector difference; determine a horizontal threshold for a horizontal block vector difference; add a first candidate to the BVP candidate list; and add a second candidate to the BVP candidate list in response to a determination that a vertical difference between the first candidate and the second candidate exceeds the vertical threshold or that a horizontal difference between the first candidate and the second candidate exceeds the horizontal threshold; wherein to determine the initial BVP for the current block of video data, the processing system is configured to select the second candidate as the initial BVP for the current block of video data.

Clause 61: The device of clause 60, wherein to construct the BVP candidate list, the processing system is further configured to skip addition of a third candidate to the BVP candidate list in response to a determination that a vertical difference between the third candidate and one of the first candidate or the second candidate is less than the vertical threshold and that a horizontal difference between the third candidate and the one of the first candidate or the second candidate is less than the horizontal threshold.

Clause 62: The device of any of clauses 58-61, further comprising a display configured to display the decoded video data.

Clause 63: The device of any of clauses 58-62, wherein the device comprises one or more of a camera, a computer, a mobile device, a broadcast receiver device, or a set-top box.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining an initial block vector predictor (BVP) for a current block of video data;
determining a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block;
selecting one of the valid BVD values as a final BVD for the current block;
adding the final BVD to the BVP for the current block to form a block vector (BV) for the current block;
generating a prediction block for the current block using the BV; and
decoding the current block using the prediction block.

2. The method of claim 1, wherein the template comprises a first template and the template size comprises a first template size along a first dimension of the template, and wherein the region of the picture includes the reference block, the first template, and a second template having a second template size along a second dimension of the template, the second dimension being orthogonal to the first dimension.

3. The method of claim 2, wherein the first template size comprises a height of the template and the second template size comprises a width of the template.

4. The method of claim 2, wherein the first template is above the reference block and the second template is to the left of the reference block.

5. The method of claim 2, wherein the first template is below the reference block and the second template is to the right of the reference block.

6. The method of claim 2, wherein the first template is above the reference block and the second template is to the right of the reference block.

7. The method of claim 2, wherein the first template is below the reference block and the second template is to the left of the reference block.

8. The method of claim 1, wherein the template is above the reference block.

9. The method of claim 1, wherein the template is to the left of the reference block.

10. The method of claim 1, wherein the template is below the reference block.

11. The method of claim 1, wherein the template is to the right of the reference block.

12. The method of claim 1, wherein determining the initial BVP for the current block of video data comprises selecting the initial BVP from a BVP candidate list, the method further comprising:
constructing the BVP candidate list, including:
determining a vertical threshold for a vertical block vector difference;
determining a horizontal threshold for a horizontal block vector difference;
adding a first candidate to the BVP candidate list; and
adding a second candidate to the BVP candidate list in response to determining that a vertical difference between the first candidate and the second candidate exceeds the vertical threshold or that a horizontal difference between the first candidate and the second candidate exceeds the horizontal threshold,
wherein determining the initial BVP for the current block of video data comprises selecting the second candidate as the initial BVP for the current block of video data.

13. The method of claim 12, wherein constructing the BVP candidate list further comprises skipping addition of a third candidate to the BVP candidate list in response to determining that a vertical difference between the third candidate and one of the first candidate or the second candidate is less than the vertical threshold and that a horizontal difference between the third candidate and the one of the first candidate or the second candidate is less than the horizontal threshold.

14. The method of claim 1, further comprising encoding the current block prior to decoding the current block.

15. A device for decoding video data, the device comprising:
a memory configured to store video data; and
a processing system comprising one or more processors implemented in circuitry and configured to:
determine an initial block vector predictor (BVP) for a current block of video data;
determine a set of valid block vector difference (BVD) values using a template size for the current block of video data, the valid BVD values being BVD values that, when added to the BVP, refer to a region of a picture that is entirely within a search area of the picture for the current block, the region including a reference block and a template for the reference block, the template having the template size and being used to perform template matching decoder-side block vector derivation for the current block;
select one of the valid BVD values as a final BVD for the current block;
add the final BVD to the BVP for the current block to form a block vector (BV) for the current block;
generate a prediction block for the current block using the BV; and
decode the current block using the prediction block.

16. The device of claim 15, wherein the template comprises a first template and the template size comprises a first template size along a first dimension of the template, and wherein the region of the picture includes the reference block, the first template, and a second template having a second template size along a second dimension of the template, the second dimension being orthogonal to the first dimension.

17. The device of claim 15, wherein to determine the initial BVP for the current block of video data, the processing system is configured to select the initial BVP from a BVP candidate list, and wherein the processing system is further configured to:
construct the BVP candidate list, wherein to construct the BVP candidate list, the processing system is configured to:
determine a vertical threshold for a vertical block vector difference;
determine a horizontal threshold for a horizontal block vector difference;
add a first candidate to the BVP candidate list; and
add a second candidate to the BVP candidate list in response to a determination that a vertical difference between the first candidate and the second candidate exceeds the vertical threshold or that a horizontal difference between the first candidate and the second candidate exceeds the horizontal threshold,
wherein to determine the initial BVP for the current block of video data, the processing system is configured to select the second candidate as the initial BVP for the current block of video data.

18. The device of claim 17, wherein to construct the BVP candidate list, the processing system is further configured to skip addition of a third candidate to the BVP candidate list in response to a determination that a vertical difference between the third candidate and one of the first candidate or the second candidate is less than the vertical threshold and that a horizontal difference between the third candidate and the one of the first candidate or the second candidate is less than the horizontal threshold.

19. The device of claim 15, further comprising a display configured to display the decoded video data.

20. The device of claim 15, wherein the device comprises one or more of a camera, a computer, a mobile device, a broadcast receiver device, or a set-top box.
